(19) United States
(12) Patent Application Publication
(10) Pub. No.: US 2013/0050069 A1
(43) Pub. Date: Feb. 28, 2013

(54) METHOD AND SYSTEM FOR USE IN PROVIDING THREE DIMENSIONAL USER INTERFACE

(71) Applicant: Takaaki Ota, San Diego, CA (US)

(72) Inventor: Takaaki Ota, San Diego, CA (US)

(73) Assignee: SONY CORPORATION, A JAPANESE CORPORATION, Tokyo (JP)

(21) Appl. No.: 13/215,451

(22) Filed: Aug. 23, 2011

(51) Int. Cl. G06F 3/01

(52) U.S. Cl. 345/156

(57) ABSTRACT

Some embodiments provide apparatuses for use in displaying a user interface, comprising: a frame, a lens mounted with the frame, a first camera, a detector, and a processor configured to: process images received from the first camera and detected data received from the detector; detect from at least the processing of the image a hand gesture relative to a three dimensional (3D) space in a field of view of the first camera and the detection zone of the detector; identify, from the processing of the image and the detected data, virtual X, Y and Z coordinates within the 3D space of at least a portion of the hand performing the gesture; identify a command corresponding to the detected gesture and the three dimensional location of the portion of the hand; and implement the command.

### BACKGROUND

1. Field of the Invention

The present invention relates generally to presentations, and more specifically to multimedia presentations.

2. Discussion of the Related Art

Numerous devices allow users to access content. Many of these playback content to be viewed by a user. Further, some playback devices are configured to playback content so that the playback appears to the user to be in three dimensions.

### SUMMARY OF THE INVENTION

Several embodiments of the invention advantageously provide benefits enabling apparatuses, systems, methods and process for use in allowing a user to interact with a virtual environment. Some of these embodiments provide apparatuses configured to display a user interface, where the apparatus comprise: a frame; a lens mounted with the frame, where the frame is configured to be worn by a user to position the lens in a line of sight of the user; a first camera mounted with the frame at a first location on the frame, where the first camera is positioned to be within a line of sight of a user when the frame is appropriately worn by the user such that an image captured by the first camera corresponds with a line of sight of the user; a detector mounted with the frame, where the second detector is configured to detect one or more objects within a detection zone that corresponds with the line of sight of the user when the frame is appropriately worn by the user; and a processor configured to: process images received from the first camera and detected data received from the detector; detect from at least the processing of the image a hand gesture relative to a virtual three dimensional (3D) space corresponding to a field of view of the first camera and the detection zone of the detector; identify, from the processing of the image and the detected data, virtual X, Y and Z coordinates within the 3D space of at least a portion of the hand performing the gesture; identify a command corresponding to the detected gesture and the three dimensional location of the portion of the hand; and implement the command.

Other embodiments provide systems for use in displaying a user interface. These systems comprise: a frame; a lens mounted with the frame, where the frame is configured to be worn by a user to position the lens in a line of sight of the user; a first camera mounted with the frame at a first location on the frame, where the first camera is positioned to align with a user's line of sight when the frame is appropriately worn by a user such that an image captured by the first camera corresponds with a line of sight of the user; a second camera mounted with the frame at a second location on the frame that is different than the first location, where the second camera is positioned to align with a user's line of sight when the frame is appropriately worn by a user such that an image captured by the second camera corresponds with the line of sight of the user; and a processor configured to: process images received from the first and second cameras; detect from the processing of the images a hand gesture relative to a three-dimensional (3D) space corresponding to the field of view of the first and second cameras; identify from the processing of the images X, Y and Z coordinates within the 3D space of at least a portion of the hand performing the gesture; identify a virtual option virtually displayed within the 3D space at the time the hand gesture is detected and corresponding to the identified X, Y and Z coordinates of the hand performing the gesture such that at least a portion of the virtual option is displayed to appear to the user as being positioned at the X, Y and Z coordinates; identify a command corresponding to the identified virtual option and the detected hand gesture; and activate the command corresponding to the identified virtual option and the detected hand gesture.

Some embodiments provide methods, comprising: receiving, while a three dimensional presentation is being displayed, a first sequence of images captured by a first camera mounted on a frame worn by a user such that a field of view of the first camera is within a field of view of a user when the frame is worn by the user; receiving, from a detector mounted with the frame, detector data of one or more objects within a detection zone that correspond with the line of sight of the user when the frame is appropriately worn by the user; processing the first sequence of images; processing the detected data detected by the detector; detecting, from the processing of the first sequences of images, a predefined non-sensor object and a predefined gesture of the non-sensor object; identifying, from the processing of the first sequence of images and the detected data, virtual X, Y and Z coordinates of at least a portion of the non-sensor object relative to a virtual three dimensional (3D) space in the field of view of the first camera and the detection zone of the detector; identifying a command corresponding to the detected gesture and the virtual 3D location of the non-sensor object; and implementing the command.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a simplified side plane view of a user interaction system configured to allow a user to interact with a virtual environment in accordance with some embodiments.

FIG. 2 shows a simplified overhead plane view of the interaction system of FIG. 1.

FIG. 3 depicts a simplified overhead plane view of the user interactive system of FIG. 1 with the user interacting with the 3D virtual environment.

FIGS. 4A-C depict simplified overhead views of a user wearing goggles according to some embodiments that can be utilized in the interactive system of FIG. 1.

FIG. 5A depicts a simplified block diagram of a user interaction system according to some embodiments.

FIG. 5B depicts a simplified block diagram of a user interaction system, according to some embodiments, comprising goggles that display multimedia content on the lenses of the goggles.

FIG. 6A depicts a simplified overhead view of the user viewing and interacting with a 3D virtual environment according to some embodiments.

FIG. 6B depicts a side, plane view of the user viewing and interacting with the 3D virtual environment of FIG. 6A.

FIG. 7 depicts a simplified flow diagram of a process of allowing a user to interact with a 3D virtual environment according to some embodiments.

FIG. 8 depicts a simplified flow diagram of a process of allowing a user to interact with a 3D virtual environment in accordance with some embodiments.

FIG. 9 depicts a simplified overhead view of a user interacting with a virtual environment provided through a user interaction system according to some embodiments.

FIG. 10 depicts a simplified block diagram of a system, according to some embodiments, configured to implement methods, techniques, devices, apparatuses, systems, servers, sources and the like in providing user interactive virtual environments.

FIG. 11 illustrates a system for use in implementing methods, techniques, devices, apparatuses, systems, servers, sources and the like in providing user interactive virtual environments in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Some embodiments provide methods, processes, devices and systems that provide users with three-dimensional (3D) interaction with a presentation of multimedia content. Further, the interaction can allow a user to use her or his hand, or an object held in their hand, to interact with a virtual 3D displayed environment and/or user interface. Utilizing image capturing and/or other detectors, the user's hand can be identified relative to a position within the 3D virtual environment and functions and/or commands can be implemented in response to the user interaction. Further, at least some of the functions and/or commands, in some embodiments, are identified based on gestures or predefined hand movements.

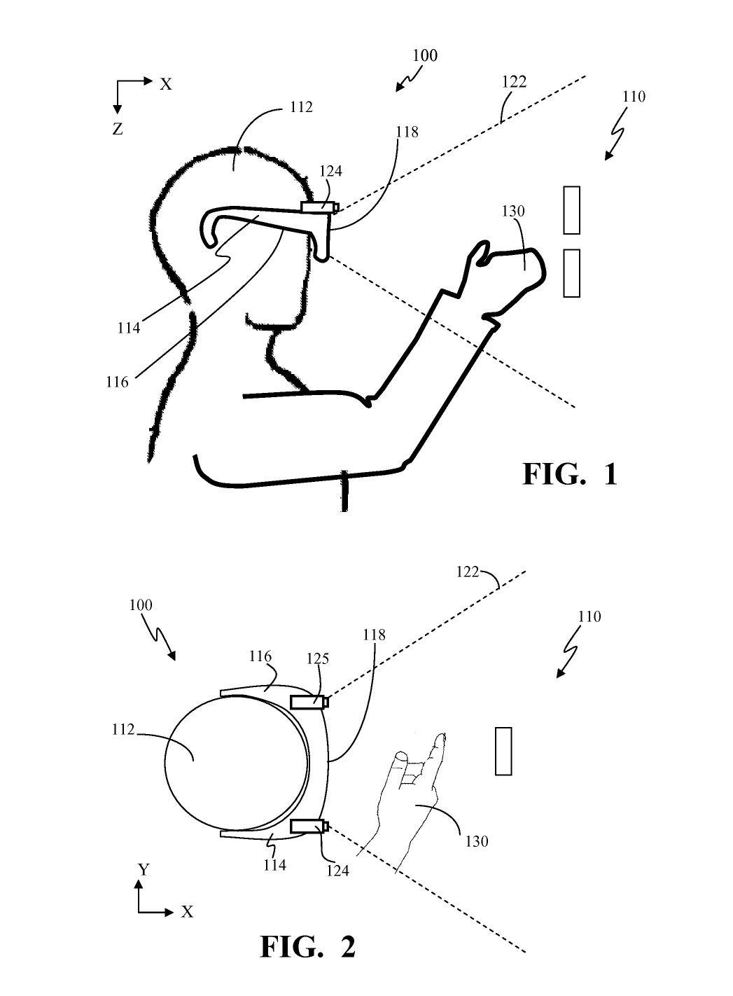

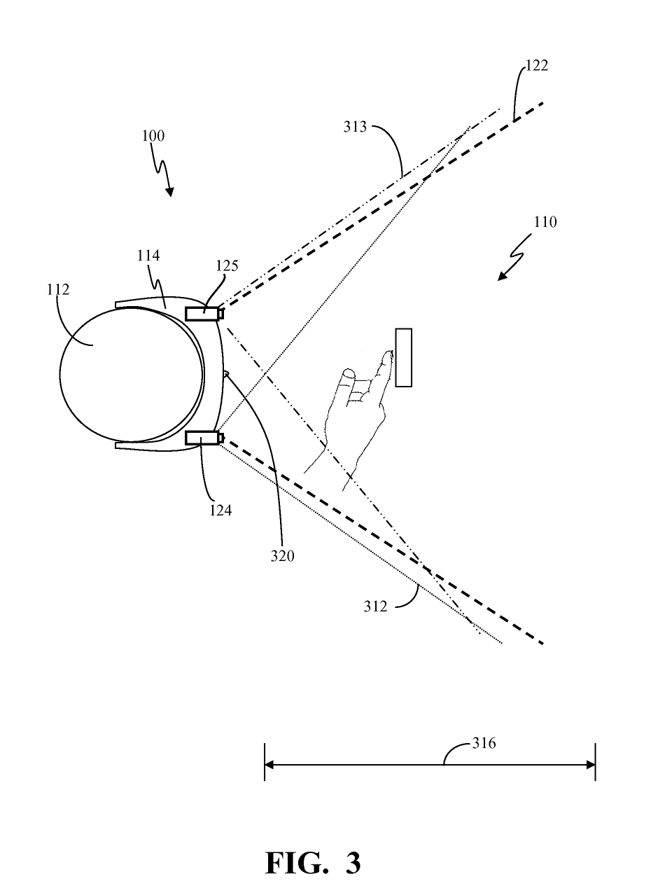

FIG. 1 depicts a simplified side plane view of a user interaction system 100 configured to allow a user 112 to interact with a 3D virtual environment 110 in accordance with some embodiments. FIG. 2 similarly shows a simplified overhead plane view of the interaction system 100 of FIG. 1 with the user 112 interacting with the 3D virtual environment 110. Referring to FIGS. 1 and 2, the user 112 wears glasses or goggles 114 (referred to below for simplicity as goggles) that allow the user to view the 3D virtual environment 110. The goggles 114 include a frame 116 and one or more lenses 118 mounted with the frame. The frame 116 is configured to be worn by the user 112 to position the lens 118 in a user's field of view 122.

One or more cameras and/or detectors 124-125 are also cooperated with and/or mounted with the frame 116. The cameras or detectors 124-125 are further positioned such that a field of view of the camera and/or a detection zone of a detector correspond with and/or is within the user's field of view 122 when the frame is appropriately worn by the user. For example, the camera 124 is positioned such that an image captured by the first camera corresponds with a field of view of the user. In some implementations, a first camera 124 is positioned on the frame 116 and a detector 125 is positioned on the frame. The use of the first camera 124 in cooperation with the detector 125 allows the user interaction system 100 to identify an object, such as the user's hand 130, a portion of the user's hand (e.g., a finger), and/or other objects (e.g., a non-sensor object), and further identify three dimensional (X, Y and Z) coordinates of the object relative to the position of the camera 124 and/or detector 125, which can be associated with X, Y and Z coordinates within the displayed 3D virtual environment 110. The detector can be substantially any relevant detector that allows the user interaction system 100 to detect the user's hand 130 or other non-sensor object and that at least aids in determining the X, Y and Z coordinates relative to the 3D virtual environment 110. The use of a camera 124 and a detector may reduce some of the processing performed by the user interaction system 100 in providing the 3D virtual environment and detecting the user interaction with that environment, than using two camera as a result of the additional image processing in some instances.

In other embodiments, a first camera 124 is positioned on the frame 116 at a first position, and a second camera 125 is positioned on the frame 116 at a second position that is different than the first position. Accordingly, when two cameras are utilized the two images generated from two different known positions allows the user interaction system 100 to determine the relative position of the user's hand 130 or other object. Further, with the first and second cameras 124-125 at know locations relative to each other, the X, Y and Z coordinates can be determined based on images captured by both cameras.

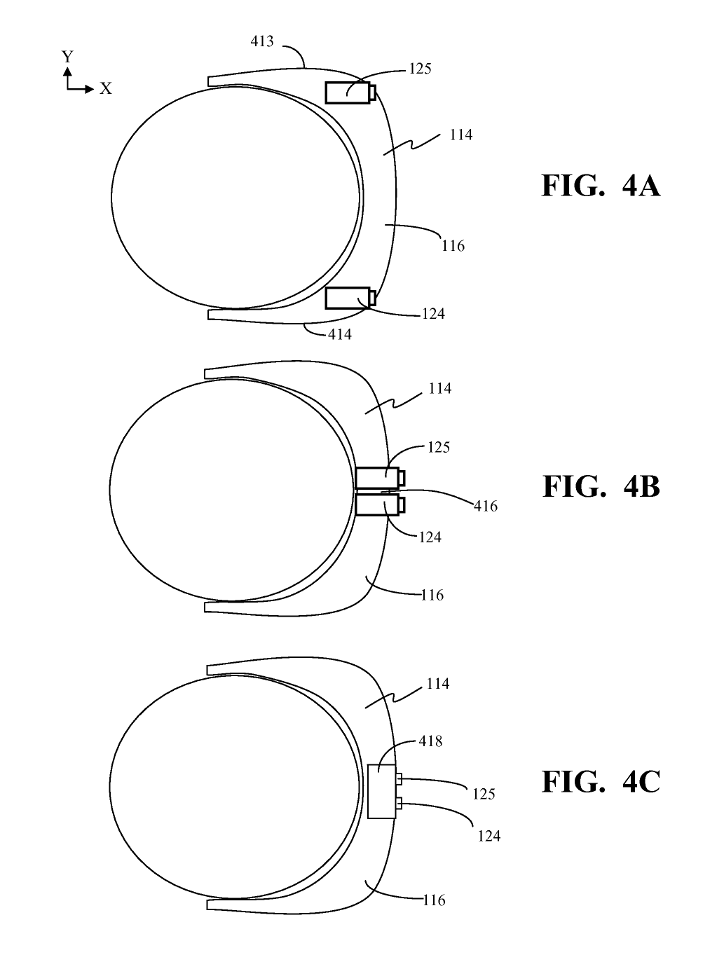

FIG. 3 depicts a simplified overhead plane view of the user 112 of FIG. 1 interacting with the 3D virtual environment 110 viewed through goggles 114. In those embodiments where two cameras 124-125 are fixed with or otherwise cooperated with the goggles 114, the first camera 124 is positioned such that, when the goggles are appropriately worn by the user, a first field of view 312 of the first camera 124 corresponds with, is within and/or overlaps at least a majority of a user's field of view 122. Similarly, the second camera 125 is positioned such that the field of view 313 of the second camera 125 corresponds with, is within and/or overlaps at least a majority of a user's field of view 122. Further, when a detector or other sensor is utilized in place of or in cooperate with the second camera 125, the detector similarly has a detector zone or area 313 that corresponds with, is within and/or overlaps at least a majority of a user's field of view 122.

With some embodiments, the depth of field (DOF) 316 of the first and/or second camera 124-125 can be limited to enhance the detection and/or accuracy of the imagery retrieved from one or both of the cameras. The depth of field 316 can be defined as the distance between the nearest and farthest objects in an image or scene that appear acceptably sharp in an image captured by the first or second camera 124-125. The depth of field of the first camera 124 can be limited to being relatively close to the user 112, which can provide a greater isolation of the hand 130 or other object attempting to be detected. Further, with the limited depth of field 316 the background is blurring making the hand 130 more readily detected and distinguishing it from the background. Additionally, with those embodiments using the hand 130 or other object being held by a user's hand, the depth of field 316 can be configured to extend from proximate the user to a distance of about or just beyond a typical user's arm length or reach. In some instances, for example, the depth of field 316 can extend from about six inches from the camera or frame to about three or four feet. This would result in a rapid defocusing of objects out side of this range and rapid decrease in sharpness outside the depth of field, isolating the hand 130 and simplifying detection and determination of a relative depth coordinate of the hand or other object (corresponding to a X coordinate along the X-axis of FIG. 3) as well as coordinates along the Y and Z axes. It is noted that the corresponding 3D virtual environment 110 does not have to be so limited. The virtual environment 110 can be substantially any configuration and can vary depending on a user's orientation, location and/or movement.

In some embodiments, images from each of a first and second camera 124-125 can each be evaluated to identify an object of interest. For example, when attempting to identify a predefined object (e.g., a user's hand 130), the images can be evaluated to identify the object by finding a congruent shape in the two images (left eye image and right eye image). Once the congruency is detected, a mapping can be performed of predefined and/or corresponding characteristic points, such as but not limited to tip of fingers, forking point between fingers, bends or joints of the finger, wrist and/or other such characteristic points. The displacement between the corresponding points between the two or more images can be measured and used, at least in part, to calculate a distance to that point from the imaging location (and effectively the viewing location in at least some embodiments). Further, the limited depth of field makes it easier to identify congruency when background imaging has less detail and texture.

Further, some embodiments use additional features to improve the detection of the user's hand 130 or other non-sensor device. For example, one or both of the first and second cameras 124-125 can be infrared (IR) cameras and/or use infrared filtering. Similarly, the one or more detector can be IR detectors. This can further reduce background effects and the like. One or more infrared emitters or lights 320 can also be incorporated in and/or mounted with the frame 116 to emit infrared light within the fields of view of the cameras 124-125. Similarly, when one or more detectors are used, one or more of these detectors can also be infrared sensors, or other such sensors that can detect the user's hand 130. For example, infrared detectors can be used in detecting thermal images. The human body is, in general, warmer than the surrounding environment. Filtering the image based on an expected heat of spectrum discriminates the human body and/or portions of the human body (e.g., hands) from surrounding inorganic matter. Additionally, in some instances where one or more infrared cameras are used in conjunction with an infrared light source (e.g., IR LED), the one or more IR cameras can accurately capture the user's hand or other predefined object even in dark environments, while to a human eye the view remains dark.

The one or more cameras 124-125 and/or one or more other cameras can further provide images that can be used in displaying one or more of the user's hands 130, such as superimposed, relative to the identified X, Y and Z coordinates of the virtual environment 110 and/or other aspects of the real world. Accordingly, the user 112 can see her/his hand relative to one or more virtual objects 324 within the virtual environment 110. In some embodiments, the images from the first and second cameras 124-125 or other cameras are forwarded to a content source that performs the relevant image processing and incorporates the images of the user's hand or graphic representations of the user's hands into the 3D presentation and virtual environment 110 being viewed by the user 112.

Additionally, the use of cameras and/or detectors at the goggles 114 provides more accurate detection of the user's hands 130 because of the close proximity of the cameras or detectors to the user's hands 130. Cameras remote from the user 112 and directed toward the user typically have to be configured with relatively large depths of field because of the potentially varying positions of users relative to the placement of these cameras. Similarly, the detection of the depth of the user's hand 130 from separate cameras directed at the user 112 can be very difficult because of the potential distance between the user and the location of the camera, and because the relative change in distance of the movement of a finger or hand is very small compared to the potential distance between a user's hand and the location of the remote camera resulting a very small angular difference that can be very difficult to accurately detect. Alternatively, with the cameras 124-125 mounted on the goggles 114, the distance from the cameras 124-125 to the user's hand 130 or finger is much smaller and the ratio of distances from the cameras to the hand or finger and the movement of the hand or finger is much smaller, with much greater angular distances.

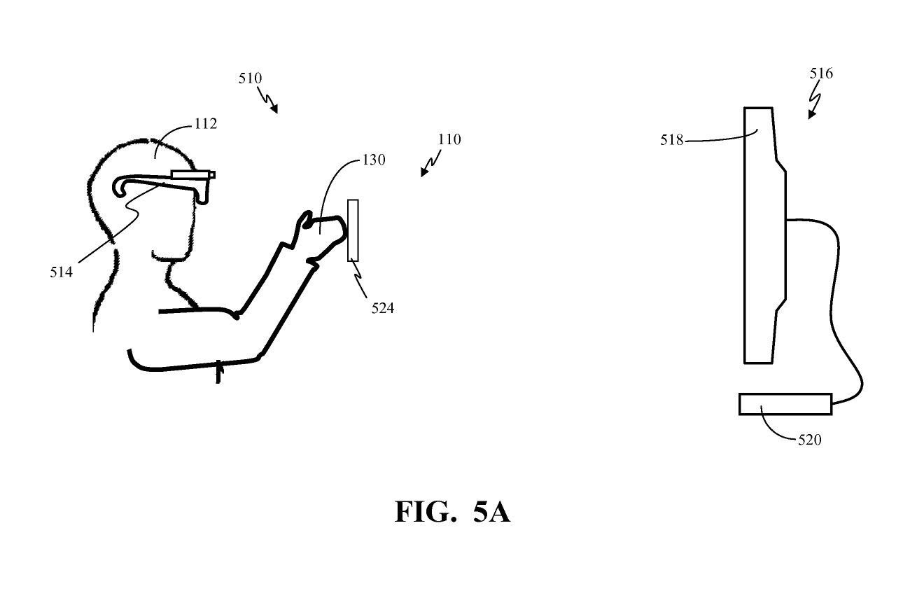

As described above, some embodiments utilize two cameras 124-125. Further, the two cameras are positioned at different locations. FIGS. 4A-C depict simplified overhead views of a user 112 wearing goggles 114 each with a different placement of the first and second cameras 124-125. For example, in FIG. 4A the first and second cameras 124-125 are positioned on opposite sides 412-413 of the frame 116. In FIG. 4B the first and second cameras 124-125 are positioned relative to a center 416 of the frame 116. In FIG. 4C the first and second cameras 124-125 are configured in a single image capturing device 418. For example, the single image capturing device 418 can be a 3D or stereo camcorder (e.g., an HDR-TD10 from Sony Corporation), a 3D camera (e.g., 3D Bloggies® from Sony Corporation) or other such device having 3D image capturing features provided through a single device. Those embodiments utilizing one or more detectors instead of or in combination with the second camera 125 can be similarly positioned and/or cooperated into a single device.

Some embodiments utilize goggles 114 in displaying back the virtual 3-D environment. Accordingly, some or all of the 3-D environment is displayed directly on the lens(es) 118 of the goggles 114. In other embodiments, glasses 114 are used so that images and/or video presented on a separate display appear to the user 112 as in three dimensions.

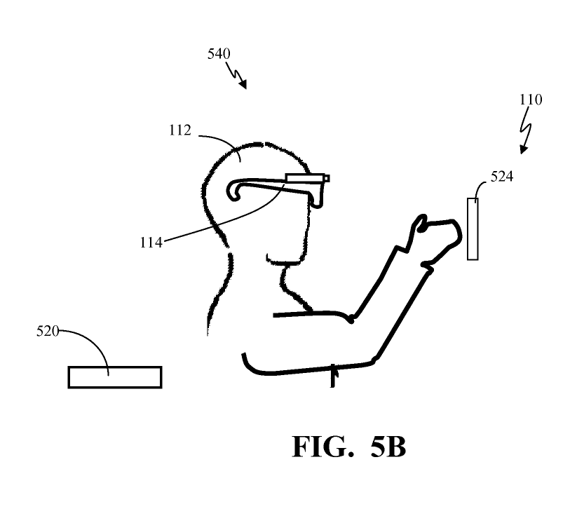

FIG. 5A depicts a simplified block diagram of a user interaction system 510, according to some embodiments. The user interaction system 510 includes the glasses 514 being worn by a user 112, a display 518 and a content source 520 of multimedia content (e.g., images, video, gaming graphics, and/or other such displayable content) to be displayed on the display 518. In some instances, the display 518 and the content source 520 can be a single unit, while in other embodiments the display 518 is separate from the content source 520. Further, in some embodiments, the content source 520 can be one or more devices configured to provide displayable content to the display 518. For example, the content source 520 can be a computer playing back local (e.g., DVD, Blu-ray, video game, etc.) or remote content (e.g., Internet content, content from another source, etc.), set-top-box, satellite system, a camera, a tablet, or other such source or sources of content. The display system 516 displays video, graphics, images, pictures and/or other such visual content. Further, in cooperation with the glasses 514 the display system 516 displays a virtual three-dimensional environment 110 to the user 112.

The glasses 514 include one or more cameras 124 and/or detectors (only one camera is depicted in FIG. 5A). The cameras 124 capture images of the user's hand 130 within the field of view of the camera. A processing system may be cooperated with the glasses 514 or may be separate from the glasses 514, such as a stand along processing system or part of any other system (e.g., part of the content source 520 or content system). The processing system receives the images and/or detected information from the cameras 124-125 and/or detector, determines X, Y and Z coordinates relative to the 3D virtual environment 110, and determines the user's interaction with the 3D virtual environment 110 based on the location on the user's hand 130 and the currently displayed 3D virtual environment 110. For example, based on the 3D coordinates of the user's hand 130, the user interaction system 510 can identify that the user is attempting to interact with a displayed virtual object 524 configured to appear to the user 112 as being within the 3D virtual environment 110 and at a location within the 3D virtual environment proximate the determined 3D coordinates of the user's hand. The virtual object 524 can be displayed on the lenses of the glasses 514 or on the display 518 while appearing in three-dimensions in the 3D virtual environment 110.

The virtual object 524 displayed can be substantially any relevant object that can be displayed and appear in the 3D virtual environment 110. For example, the object can be a user selectable option, a button, virtual slide, image, character, weapon, icon, writing device, graphic, table, text, keyboard, pointer, or other such object. Further, any number of virtual objects can be displayed.

In some embodiments, the glasses 514 are in communication with the content source 520 or other relevant device that performs some or all of the detector and/or image processing. For example, in some instances, the glasses may include a communication interface with one or more wireless transceivers that can communication image and/or detector data to the content source 520 such that the content source can perform some or all of the processing to determine relative virtual coordinates of the user's hand 130 and/or portion of the user's hand, identify gestures, identify corresponding commands, implement the commands and/or other processing. In those embodiments where some or all of the processing is performed at the glasses 514, the glasses can include one or more processing systems and/or couple with one or more processing systems (e.g., systems that are additionally carried by the user 112 or in communication with the glasses 514 via wired or wireless communication).

FIG. 5B depicts a simplified block diagram of a user interaction system 540, according to some embodiments. The user 112 wears goggles 114 that display multimedia content on the lenses 118 of the goggles such that a separate display is not needed. The goggles 114 are in wired or wireless communication with a content source 520 that supplies content to be displayed and/or played back by the goggles.

As described above, the content source 520 can be part of the goggles 114 or separate from the goggles. The content source 520 can supply content and/or perform some or all of the image and/or detector processing. Communication between the content source 520 and the goggles 114 can be via wired (including optical) and/or wireless communication.

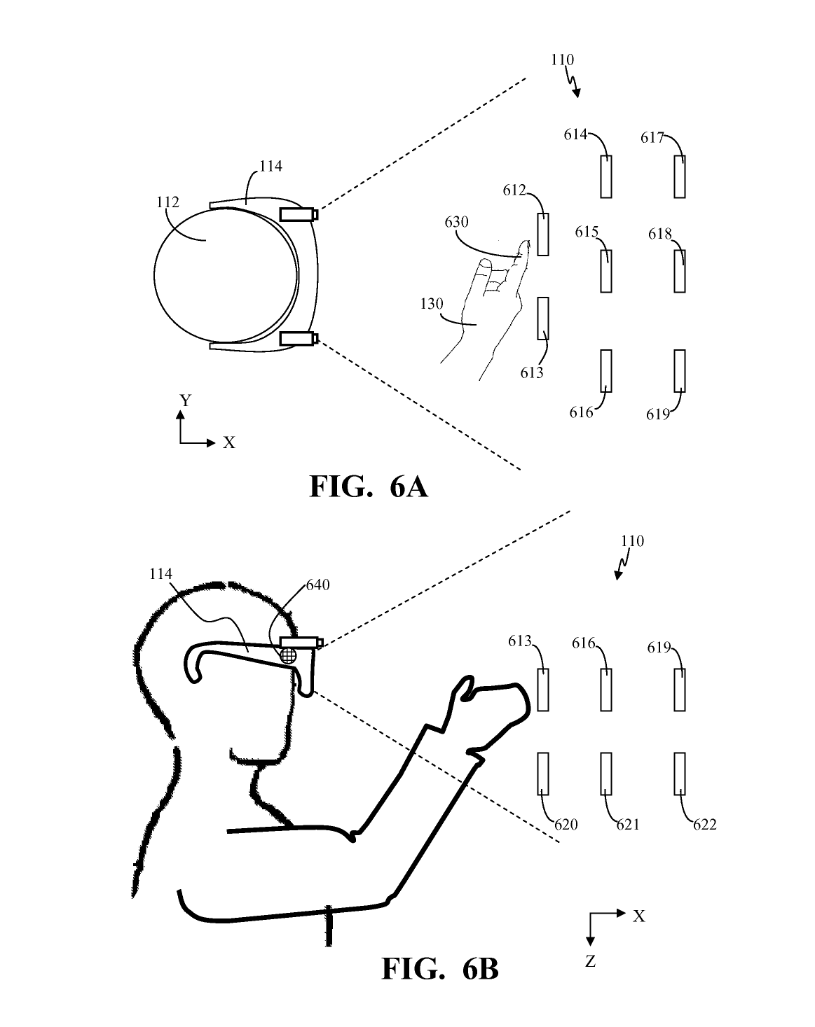

FIG. 6A depicts a simplified overhead view of the user 112 viewing and interacting with a 3D virtual environment 110; and FIG. 6B depicts a side, plane view of the user 112 viewing and interacting with the 3D virtual environment 110 of FIG. 6A. Referring to FIGS. 6A-B, in the 3D virtual environment, multiple virtual objects 612-622 are visible to the user 112. The user can interact with one or more of the virtual objects, such as by virtually touching a virtual object (e.g., virtual object 612) with the user's hand 130. For example, the virtual environment 110 can be or can include a displayed 3D virtual dashboard that allows precise user control of the functions available through the dashboard. In other instances, the user may interact with the virtual environment, such as when playing a video game and at least partially controlling the video game, the playback of the game and/or one or more virtual devices, characters or avatar within the game. As described above, the virtual objects 612-622 can be displayed on the lenses 118 of the goggles 114 or on a separate display 518 visible to the user 112 through glasses 114. The virtual objects 612-622 can be displayed to appear to the user 112 at various locations within the 3D virtual environment 110, including distributed in the X, Y and/or Z directions. Accordingly, the virtual objects 612-622 can be displayed at various distances, depths and/or in layers relative to the user 112.

The user interaction system 100 captures images while the presentation is being displayed to the user. The images and/or detector information obtained during the presentation are processed to identify the user's hand 130 or other predefined object. Once identified, the user interactive system identifies the relative X, Y and Z coordinates of at least a portion of the user's hand (e.g., a finger 630), including the virtual depths (along the X-axis) of the portion of the user's hand. Based on the identified location of the user's hand or portion of the user's hand within the 3D virtual environment 110, the user interaction system 100 identifies the one or more virtual objects 612-622 that the user is attempting to touch, select, move or the like. Further, the user interaction system 100 can identify one or more gestures being performed by the user's hand, such as selecting, pushing, grabbing, moving, dragging, attempting to enlarge, or other such actions. In response, the user interactive system can identify one or more commands to implement associated with the identified gesture, the location of the user's hand 130 and the corresponding object proximate the location of the user's hand. For example, a user 112 may select an object (e.g., a picture or group of pictures) and move that object (e.g., move the picture or group of picture into a file or another group of pictures), turn the object (e.g., turn a virtual knob), push a virtual button, zoom (e.g., pinch and zoom type operation), slide a virtual slide bar indicator, sliding objects, pushing or pulling objects, scrolling, swiping, keyboard entry, aim and/or activate a virtual weapon, move a robot, or take other actions. Similarly, the user can control the environment, such as transitioning to different controls, different displayed consoles or user interfaces, different dashboards, activate different applications, and other such control, as well as more complicated navigation (e.g., content searching, audio and/or video searching, playing video games, etc.).

In some embodiments, an audio system 640 may be cooperated with and/or mounted with the goggles 114. The audio system 640 can be configured in some embodiments to detect audio content, such as words, instructions, commands or the like spoken by the user 112. The close proximity of the audio system 640 can allow for precise audio detection, and readily distinguished from background noise and/or noise from the presentation. Further, the processing of the audio can be performed at the goggles 114, partially at the goggles and/or remote from the goggles. For example, audio commands, such as utterances of the words such as close, move, open, next, combine, and other such commands, could be spoken by the user and detected by the audio system 640 to implement commands.

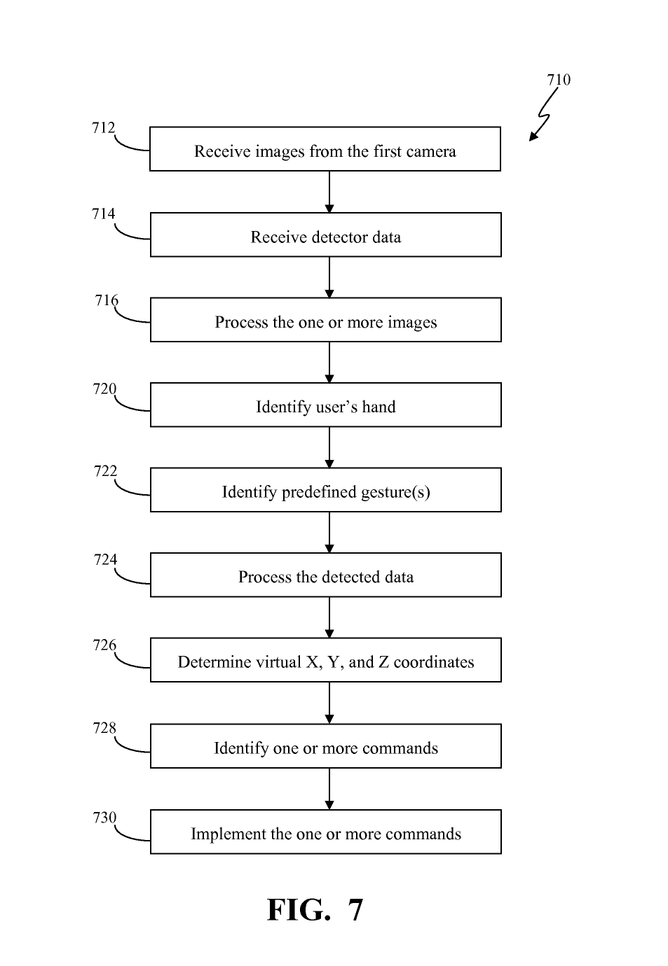

FIG. 7 depicts a simplified flow diagram of a process 710 of allowing a user to interact with a 3D virtual environment according to some embodiments. In step 712, one or more images, a sequence of images and/or video are received, such as from the first camera 124. In step 714, detector data is received from a detector cooperated with the goggles 114. Other information, such as other camera information, motion information, location information, audio information or the like can additional be received and utilized. In step 716, the one or more images from the first camera 124 are processed. This processing can include decoding, decompressing, encoding, compression, image processing and other such processing. In step 720 the user's hand or other non-sensor object is identified within the one or more images. In step 722, one or more predefined gestures are additionally identified in the image processing.

In step 724, the detected data is processed and in cooperation with the image data the user's hand or the non-sensor object is detected and location information is determined. In step 726, virtual X, Y and Z coordinates are determined of at least a portion of the user's hand 130 relative to the virtual environment 110 (e.g., a location of a tip of a finger is determined based on the detected location and gesture information). In step 728, one or more commands are identified to be implemented based on the location information, gesture information, relative location of virtual objects and other such factors. Again, the commands may be based on one or more virtual objects being virtually displayed at a location proximate the identified coordinates of the user's hand within the 3D virtual environment. In step 730, the one or more commands are implemented. It is noted, that in some instances the one or more commands may be dependent on a current state of the presentation (e.g., based on a point in playback of a movie when the gesture is detected, what part of a video game is being played back, etc.). Similarly, the commands implemented may be dependent on subsequent actions, such as subsequent actions taken by a user in response to commands being implemented. Additionally or alternatively, some gestures and/or corresponding locations where the gestures are made may be associated with global commands that can be implemented regardless of a state of operation of a presentation and/or the user interaction system 100.

As described above, the process implements image processing in step 716 to identify the user's hand 130 or other object and track the movements of the hand. In some implementations the image processing can include processing by noise reduction filtering (such as using a two dimensional low pass filter and isolation point removal by median filter, and the like), which may additionally be followed by a two dimensional differential filtering that can highlight the contour lines of the user's hand or other predefined object. Additionally or alternatively, a binary filtering can be applied, which in some instances can be used to produce black and white contour line images. Often the contour lines are thick lines and/or thick areas. Accordingly, some embodiments implement a shaving filter (e.g., black areas extend into white areas without connecting one black area into another black area, which breaks the white line) is applied to thin out the lines and/or areas.

The image processing can in some embodiments further include feature detection algorithms that trace the lines and observe the change of tangent vectors and detect the feature points where vectors change rapidly, which can indicate the location of corners, ends or the like. For example, these feature points can be tips of the fingers, the fork or intersection between fingers, joints of the hand, and the like. Feature points may be further grouped by proximity and matched against references, for example, by rotation and scaling. Pattern matching can further be performed by mapping a group of multiple data into a vector space and the resemblance is measured by the distance between two vectors in this space. Once the user's hand or other object is detected the feature point can be continuously tracked in time to detect the motion of the hand. One or more gestures are defined, in some embodiments, as the motion vector of the feature points (e.g., displacement of the feature point in time). For example, finger motion can be determined by the motion vector of a feature point; hand waving motion can be detected by the summed up motion vector of a group of multiple feature points, etc. The dynamic accuracy may, in some embodiments, be enhanced by the relative static relationship between a display screen and the camera location in the case of goggles. In cases where one or more cameras are mounted on see-through glasses (i.e., the display is placed outside of the glasses), the distant display may also be detected, for example by detecting the feature points of the display (e.g., four corners, four sides, one or more reflective devices, one or more LEDs, one or more IR LEDs). The static accuracy of the gesture location and virtual 3D environment may be further improved by applying a calibration (e.g., the system may ask a user to touch a virtual 3D reference point in the space with a finger prior to starting or while using to use the system). Similarly, predefined actions (such as the touching of a single virtual button (e.g., “play” or “proceed” button may additionally or alternatively be used). The above processing can be implemented for each image and/or series of images captured by the cameras 124-125.

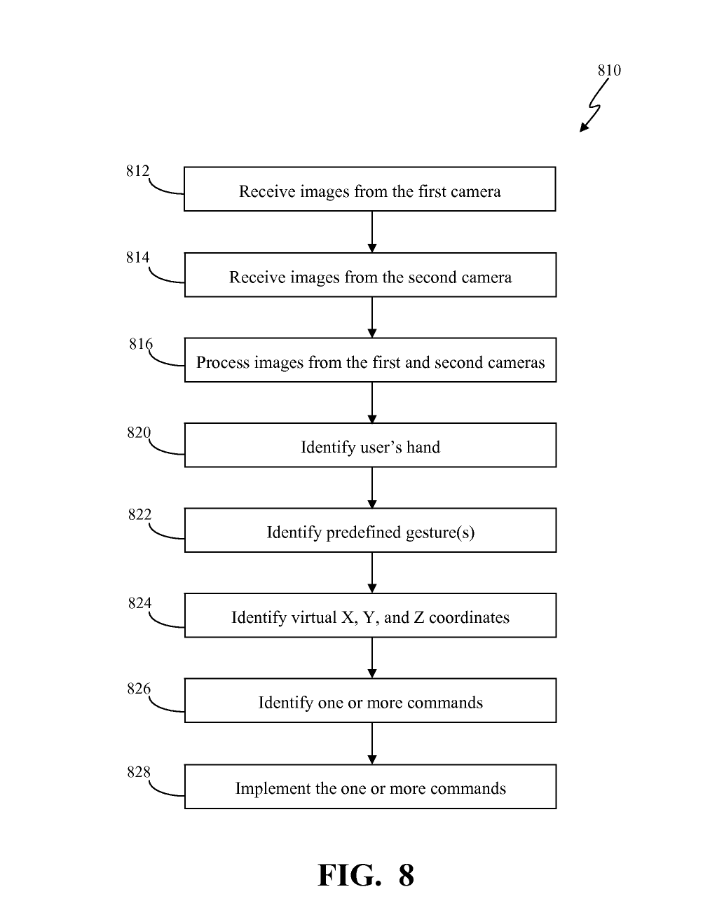

FIG. 8 depicts a simplified flow diagram of a process 810 of allowing a user to interact with a 3D virtual environment in accordance with some embodiments where the system employs two or more cameras 124-125 in capturing images of a user's hands 130 or other non-sensor object. In step 812, one or more images, a sequence of images and/or video are received from the first camera 124. In step 814, one or more images, a sequence of images and/or video are received from the second camera 125. In step 816, the one or more images from the first and second cameras 124-125 are processed.

In step 820 the user's hand or other non-sensor object is identified within the one or more images. In step 822, one or more predefined gestures are additionally identified from the image processing. In step 824, the virtual X, Y and Z coordinates of the user's hand 130 are identified relative to the goggles 114 and the virtual environment 110. In step 826 one or more commands associated with the predefined gesture and the relative virtual coordinates of the location of the hand are identified. In step 828, one or more of the identified commands are implemented.

Again, the user interactive system employs the first and second cameras 124-125 and/or detector in order to not only identify Y and Z coordinates, but also a virtual depth coordinate (X coordinate) location of the user's hand 130. The location of the user's hand in combination with the identified gesture allows the user interaction system 100 to accurately interpret the user's intent and take appropriate action allowing the user to virtually interact and/or control the user interaction system 100 and/or the playback of the presentation.

Some embodiments further extend the virtual environment 110 to extend beyond a users field of view 122 or vision. For example, some embodiments extend the virtual environment outside the user's immediate field of view 122 such that the user can turns her or his head to view additional portions of the virtual environment 110. The detection of the user's movement can be through one or more processes and/or devices. For example, processing of sequential images from one or more cameras 124-125 on the goggles 114 may implemented. The detected and captured movements of the goggles 114 and/or the user 112 can be used to generate position and orientation data by gathered on an image-by-image or frame-by-frame basis, the data can be used to calculate many physical aspects of the movement of the user and/or the goggles, such as for example acceleration and velocity along any axis, as well as tilt, pitch, yaw, roll, and telemetry points.

Additionally or alternatively, in some instances the goggles 114 can include one or more inertial sensors, compass devices and/or other relevant devices that may aid in identifying and quantifying a user's movement. For example, the goggles 114 can be configured to include one or more accelerometers, gyroscopes, tilt sensors, motion sensors, proximity sensor, other similar devices or combinations thereof. As examples, acceleration may be detected from a mass elastically coupled at three or four points, e.g., by springs, resistive strain gauge material, photonic sensors, magnetic sensors, hall-effect devices, piezoelectric devices, capacitive sensors, and the like.

In some embodiments, other cameras or other sensors can track the user's movements, such as one or more cameras at a multimedia or content source 520 and/or cooperated with the multimedia source (e.g., cameras tracking a user's movements by a gaming device that allows a user to play interactive video games). One or more lights, array of lights or other such detectable objects can be included on the goggles 114 that can be used to identify the goggles and track the movements of the goggles.

Accordingly, in some embodiments the virtual environment 110 can extend beyond the user's field of view 122. Similarly, the virtual environment 110 can depend on what the user is looking at and/or the orientation of the user.

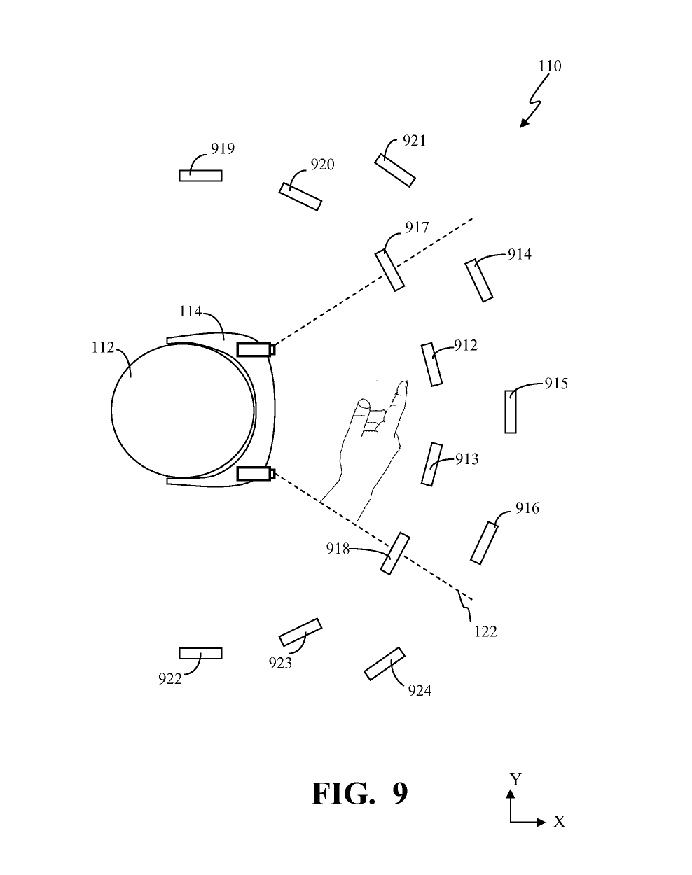

FIG. 9 depicts a simplified overhead view of a user 112 interacting with a virtual environment 110 according to some embodiments. As shown, the virtual environment extends beyond the user's field of view 122. In the example representation of FIG. 9, multiple virtual objects 912-916 are within the user's field of view 122, multiple virtual objects 917-918 are partially within the user's field of view, while still one or more other virtual objects 919-924 are beyond the user's immediate field of view 122. By tracking the user's movements and/or the movement of the goggles 114 the displayed virtual environment 110 can allow a user to view other portions of the virtual environment 110. In some instances, one or more indicators can be displayed that indicate that the virtual environment 110 extends beyond the user's field of view 122 (e.g., arrows, or the like). Accordingly, the virtual environment can extend, in some instances, completely around the user 112 and/or completely surround the user in the X, Y and/or Z directions. Similarly, because of the view is a virtual environment, the virtual environment 110 may potential display more than three axis of orientation and/or hypothetical orientations depending on a user's position, direction of view of view 122, detected predefined gestures (e.g., location of the user's hand 130 and the gestures performed by the user) and/or the context of the presentation.

Further, in some instances, the virtual environment may change depending on the user's position and/or detected gestured performed by the user. As an example, the goggles 114 may identify or a system in communication with the goggles may determine that the user 112 is looking at a multimedia playback device (e.g., through image detection and/or communication from the multimedia playback device), and accordingly display a virtual environment that allows a user to interact with the multimedia playback device. Similarly, the goggles 114 may detect or a system associated with the goggles may determine that the user is now looking at an appliance, such as a refrigerator. The goggles 114, based on image recognition and/or in communication with the refrigerator, may adjust the virtual environment 110 and display options and/or information associated with the refrigerator (e.g., internal temperature, sensor data, contents in the refrigerator when known, and/or other such information). Similarly, the user may activate devices and/or control devices through the virtual environment. For example the virtual environment may display virtual controls for controlling an appliance, a robot, a medical device or the like such that the appliance, robot or the like takes appropriate actions depending on the identified location of the user's hand 130 and the detected predefined gestures. As a specific example, a robotic surgical device for performing medical surgeries can be controlled by a doctor through the doctor's interaction with the virtual environment 110 that displays relevant information, images and/or options to the doctor. Further, the doctor does not even need to be in the same location as the patient and robot. In other instances, a user may activate an overall household control console and select a desired device with which the user intends to interact.

Similarly, when multiple displays (e.g., TVs, computer monitors or the like) are visible, the use of the cameras and/or orientation information can allow the user interaction system 100 in some instances to identify which display the user is currently looking at and adjust the virtual environment, commands, dashboard etc. relative to the display of interest. Additionally or alternatively, a user 112 can perform a move command of a virtual object, such as from one display to another display, from one folder to another folder or the like. In other instances, such as when viewing feeds from multiple security cameras, different consoles, controls and/or information can be displayed depending on which security camera a user is viewing.

In some embodiments, the virtual environment may additionally display graphics information (e.g., the user's hands 130) in the virtual environment, such as when the goggles 114 inhibit a user from seeing her/his own hands and/or inhibits the user's view beyond the lens 118. The user's hands or other real world content may be superimposed over other content visible to the user. Similarly, the virtual environment can include displaying some or all of the real world beyond the virtual objects and/or the user's hands such that the user can see what the user would be seeing if she or he removed the goggles. The display of the real world can be accomplished, in some embodiments, through the images captured through one or both of the first and second cameras 124-125, and/or through a separate camera, and can allow a user to move around while still wearing the goggles.

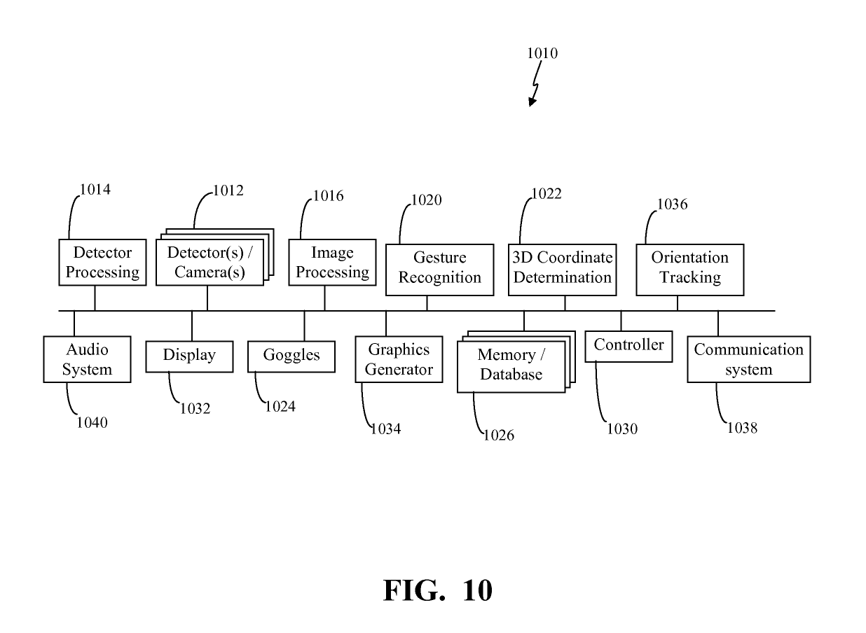

FIG. 10 depicts a simplified block diagram of a system 1010 according to some embodiments that can be used in implementing some or all of the user interaction system 100 or other methods, techniques, devices, apparatuses, systems, servers, sources and the like in providing user interactive virtual environments described above or below. The system 1010 includes one or more cameras or detectors 1012, detector processing systems 1014, image processing systems 1016, gesture recognition systems 1020, 3D coordinate determination systems, goggles or glasses 1024, memory and/or databases 1026 and controllers 1030. Some embodiments further include a display 1032, graphics generator system 1034, an orientation tracking system 1036, a communication interface or system 1038 with one or more transceivers, audio detection system 1040 and/or other such systems.

The cameras and/or detectors 1012 detect the user's hand or other predefined object. In some instances, the detection can include IR motion sensor detection, directional heat sensor detection, and/or cameras that comprise two dimensional light sensors and are capable of capturing a series of two dimensional images progressively. In some embodiments, the detector processing system 1014 processes the signals from one or more detectors, such as an IR motion sensor, and in many instances has internal signal thresholds to limit the detection to about a user's arm length, and accordingly detects an object or user's hand within about the arm distance. The image processing system 1016, as described above, provides various image processing functions such as, but not limited to, filtering (e.g., noise filtering, two dimensional differential filtering, binary filtering, line thinning filtering, feature point detection filtering, etc.), and other such image processing.

The gesture recognition system 1020 detects feature points and detects patterns for a user's fingers and hands, or other features of a predefined object. Further, the gesture recognition system tracks feature points in time to detect gesture motion. The 3D coordinate determination system, in some embodiments, compares the feature points from one or more images of a first camera image and one or more images of a second camera, and measures the displacement between corresponding feature point pairs. The displacement information can be used, at least in part, in calculating a depth or distance of the feature point location.

As described above, the goggles 1024 are cooperated with at least one camera and a detector or a second camera. Based on the information captured by the cameras and/or detectors 1012 the detector processing system 1014 and image processing system 1016 identify the user's hands and provide the relevant information to the 3D coordinate determination system 1022 and gesture recognition system 1020 to identify a relative location within the 3D virtual environment and the gestures relative to the displayed virtual environment 110. In some instances, the image processing can perform addition processing to improve the quality of the captured images and/or the objects being captured in the image. For example, image stabilization can be preformed, lighting adjustments can be performed, and other such processing. The goggles 124 can have right and left display units that show three dimensional images in front of the viewer. In those instances where glasses are used, the external display 1032 is typically statically placed with the user positioning her/himself to view the display through the glasses.

The memory and/or databases 1026 can be substantially any relevant computer and/or processor readable memory that is local to the goggles 1024 and/or the controller 1030, or remote and accessed through a communication channel, whether via wired or wireless connections. Further, the memory and/or databases can store substantially any relevant information, such as but not limited to gestures, commands, graphics, images, content (e.g., multimedia content, textual content, images, video, graphics, animation content, etc.), history information, user information, user profile information, and other such information and/or content. Additionally, the memory 1026 can store image data, intermediate image data, multiple frames of images to process motion vectors, pattern vector data for feature point pattern matching, etc.

The display 1032 can display graphics, movies, images, animation and/or other content that can be visible to the user or other users, such as a user wearing glasses 1024 that aid in displaying the content in 3D. The graphics generator system 1034 can be substantially any graphics generator for generating graphics from code or the like, such as with video game content and/or other such content, to be displayed on the goggle 114 or the external display 1032 to show synthetic three dimensional images.

The orientation tracking system 1036 can be implemented in some embodiments to track the movements of the user 112 and/or goggles 1024. The orientation tracking system, in some embodiments, can track the orientation of the goggles 114 by one or more orientation sensors, cameras, or other such devices and/or combinations thereof. For example, in some embodiments one or more orientation sensor comprising three X, Y and Z linear motion sensors are included. One or more axis rotational angular motion sensors can additionally or alternatively be used (e.g., three X, Y and Z axis rotational angular motion sensors). The use of a camera can allow the detection of the change of orientation by tracking a static object, such a display screen (e.g., four corner feature points).

Some embodiments further include one or more receivers, transmitters or transceivers 1038 to provide internal communication between components and/or external communication, such as between the goggles 114, a gaming console or device, external display, external server or database accessed over a network, or other such communication. For example, the transceivers 1038 can be used to communication with other devices or systems, such as over a local network, the Internet or other such network. Further, the transceivers 1038 can be configured to provide wired, wireless, optical, fiber optical cable or other relevant communication. Some embodiments additionally include one or more audio detection systems that can detect audio instructions and/or commands from a user and aid in interpreting and/or identifying user's intended interaction with the system 1010 and/or the virtual environment 110. For example, some embodiments incorporate and/or cooperate with one or more microphones on the frame 116 of the goggles 114. Audio processing can be performed through the audio detection system 1040, which can be preformed at the goggles 114, partially at the goggles or remote from the goggles. Additionally or alternatively, the audio system can playback, in some instances, audio content to be heard by the user (e.g., through headphones, speakers or the like). Further, the audio detection system 1040 may provide different attenuation to multiple audio channels and/or apply an attenuation matrix to multi-channel audio according to the orientation tracking in order to rotate and match the sound space to the visual space.

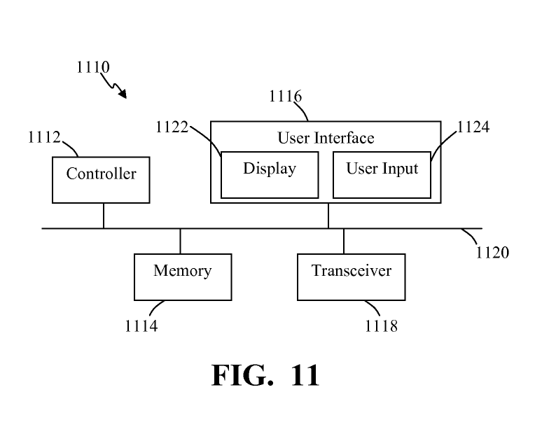

The methods, techniques, systems, devices, services, servers, sources and the like described herein may be utilized, implemented and/or run on many different types of devices and/or systems. Referring to FIG. 11, there is illustrated a system 1100 that may be used for any such implementations, in accordance with some embodiments. One or more components of the system 1100 may be used for implementing any system, apparatus or device mentioned above or below, or parts of such systems, apparatuses or devices, such as for example any of the above or below mentioned user interaction system 100, system 1010, glasses or goggles 114, 1024, first or second cameras 124-125, cameras or detectors 1012, display system 516, display 518, content source 520, image processing system 1016, detector processing system 1014, gesture recognition system 1020, 3D coordinate determination system 1022, graphics generator system 1034, controller 1030, orientation tracking system 1036 and the like. However, the use of the system 1100 or any portion thereof is certainly not required.

By way of example, the system 1100 may comprise a controller or processor module 1112, memory 1114, a user interface 1116, and one or more communication links, paths, buses or the like 1120. A power source or supply (not shown) is included or coupled with the system 1100. The controller 1112 can be implemented through one or more processors, microprocessors, central processing unit, logic, local digital storage, firmware and/or other control hardware and/or software, and may be used to execute or assist in executing the steps of the methods and techniques described herein, and control various communications, programs, content, listings, services, interfaces, etc. The user interface 1116 can allow a user to interact with the system 1100 and receive information through the system. In some instances, the user interface 1116 includes a display 1122 and/or one or more user inputs 1124, such as a remote control, keyboard, mouse, track ball, game controller, buttons, touch screen, etc., which can be part of or wired or wirelessly coupled with the system 1100.

Typically, the system 1100 further includes one or more communication interfaces, ports, transceivers 1118 and the like allowing the system 1100 to communication over a distributed network, a local network, the Internet, communication link 1120, other networks or communication channels with other devices and/or other such communications. Further the transceiver 1118 can be configured for wired, wireless, optical, fiber optical cable or other such communication configurations or combinations of such communications.

The system 1100 comprises an example of a control and/or processor-based system with the controller 1112. Again, the controller 1112 can be implemented through one or more processors, controllers, central processing units, logic, software and the like. Further, in some implementations the controller 1112 may provide multiprocessor functionality.

The memory 1114, which can be accessed by the controller 1112, typically includes one or more processor readable and/or computer readable media accessed by at least the controller 1112, and can include volatile and/or nonvolatile media, such as RAM, ROM, EEPROM, flash memory and/or other memory technology. Further, the memory 1114 is shown as internal to the system 1110; however, the memory 1114 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. The memory 1114 can store code, software, executables, scripts, data, content, multimedia content, gestures, coordinate information, 3D virtual environment coordinates, programming, programs, media stream, media files, textual content, identifiers, log or history data, user information and the like.

One or more of the embodiments, methods, processes, approaches, and/or techniques described above or below may be implemented in one or more computer programs executable by a processor-based system. By way of example, such a processor based system may comprise the processor based system 1100, a computer, a set-to-box, an television, an IP enabled television, a Blu-ray player, an IP enabled Blu-ray player, a DVD player, entertainment system, gaming console, graphics workstation, tablet, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for allowing one or more users to interact with a 3D virtual environment 110. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: receiving, while a three dimensional presentation is being displayed, a first sequence of images captured by a first camera mounted on a frame worn by a user such that a field of view of the first camera is within a field of view of a user when the frame is worn by the user; receiving, from a detector mounted with the frame, detector data of one or more objects within a detection zone that correspond with the line of sight of the user when the frame is appropriately worn by the user; processing the first sequence of images; processing the detected data detected by the detector; detecting, from the processing of the first sequences of images, a predefined non-sensor object and a predefined gesture of the non-sensor object; identifying, from the processing of the first sequence of images and the detected data, virtual X, Y and Z coordinates of at least a portion of the non-sensor object relative to a virtual three dimensional (3D) space in the field of view of the first camera and the detection zone of the detector; identifying a command corresponding to the detected gesture and the virtual 3D location of the non-sensor object; and implementing the command.

Other embodiments provide one or more computer-readable storage mediums storing one or more computer programs configured for use with a computer simulation, the one or more computer programs configured to cause a computer and/or processor based system to execute steps comprising: causing to be displayed a three dimensional presentation; receiving, while the three dimensional presentation is being displayed, a first sequence of images captured by a first camera mounted on a frame worn by a user such that a field of view of the first camera is within a field of view of a user when the frame is worn by the user; receiving, while the three dimensional presentation is being displayed, a second sequence of images captured by a second camera mounted on the frame such that a field of view of the second camera is within the field of view of a user when the frame is worn by the user; processing both the first and second sequences of images; detecting, from the processing of the first and second sequences of images, a predefined non-sensor object and a predefined gesture of the non-sensor object; determining from the detected gesture a three dimensional coordinate of at least a portion of the non-sensor object relative to the first and second cameras; identifying a command corresponding to the detected gesture and the three dimensional location of the non-sensor object; and implementing the command.

Accordingly, users 112 can interact with a virtual environment 110 to perform various functions based on the detected location of a user's hand 130 or other predefined object relative to the virtual environment and the detected gesture. This can allow users to perform substantially any function through the virtual environment, including performing tasks that are remote from the user. For example, a user can manipulate robotic arms (e.g., in a military or bomb squad situation, manufacturing situation, etc.) by the user's hand movements (e.g., by reaching out and picking up a virtually displayed object) such that the robot takes appropriate action (e.g., the robot actually picks up the real object). In some instances, the actions available to the user may be limited, for example, as a result of the capabilities of the device being controlled (e.g., a robot may only have two “fingers”). In other instances, however, the processing knows the configuration and/or geometry of the robot and can extrapolate from the detected movement of the user's hand 130 to identify relevant movements that the robot can perform (e.g., limitations of possible commands because of the capabilities, geometry of the robot).

Vehicles and/or airplanes can also be controlled through the user's virtual interaction with virtual controls. This can allow the control of a vehicle or plane to be instantly upgradeable because controls are virtual. Similarly, the control can be performed remotely from the vehicle or plane based on the presentation and/or other information provided to the operator. The virtual interaction can similarly be utilized in medical applications. For example, images may be superimposed over a patient and/or robotic applications can be used to take actions (e.g., where steady, non jittery actions must be taken).

Further still, some embodiments can be utilized in education, providing for example, a remote educational experience. A student does not have to be in the same room as the teacher, but all the students see the same thing, and a remote student can virtually write on the black board. Similarly, users can virtual interact with books (e.g., text books). Additional controls can be provided (e.g., display graphs while allowing user to manipulate parameters to see how that would affect a graph). Utilizing the cameras 124-125 or other camera on the goggles 114, text book can be identified and/or which page of the text book is being viewed. The virtual environment can provide highlighting of text, allow a user to highlight text, create outlines, virtually annotate a text book and/or other actions, while storing the annotations and/or markups.

Many of the functional units described in this specification have been labeled as systems, devices or modules, in order to more particularly emphasize their implementation independence. For example, a system may be implemented as a hardware circuit comprising custom VLSI circuits or gate arrays, off-the-shelf semiconductors such as logic chips, transistors, or other discrete components. A system may also be implemented in programmable hardware devices such as field programmable gate arrays, programmable array logic, programmable logic devices or the like.

Systems, devices or modules may also be implemented in software for execution by various types of processors. An identified system of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a system of executable code could be a single instruction, or many instructions, and may even be distributed over several different code segments, among different programs, and across several memory devices. Similarly, operational data may be identified and illustrated herein within systems, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. An apparatus displaying a user interface, the apparatus comprising:
a frame;
a lens mounted with the frame, where the frame is configured to be worn by a user to position the lens in a line of sight of the user;
a first camera mounted with the frame at a first location on the frame, where the first camera is positioned to be within a line of sight of a user when the frame is appropriately worn by the user such that an image captured by the first camera corresponds with a line of sight of the user;
a detector mounted with the frame, where the second detector is configured to detect one or more objects within a detection zone that corresponds with the line of sight of the user when the frame is appropriately worn by the user; and
a processor configured to:
process images received from the first camera and detected data received from the detector;
detect from at least the processing of the image a hand gesture relative to a virtual three-dimensional (3D) space corresponding to a field of view of the first camera and the detection zone of the detector;
identify, from the processing of the image and the detected data, virtual X, Y and Z coordinates within the 3D space of at least a portion of the hand performing the gesture;
identify a command corresponding to the detected gesture and the three dimensional location of the portion of the hand; and
implement the command.

2. The apparatus of claim 1, wherein the processor is further configured to:
identify a virtual option virtually displayed within the 3D space at the time the hand gesture is detected and corresponding to the identified X, Y and Z coordinates of the hand performing the gesture such that at least a portion of the virtual option is displayed to appear to the user as being positioned proximate the X, Y and Z coordinates;
wherein the processor in identifying the command is further configured to identify the command corresponding to the identified virtual option and the detected hand gesture, and the processor in implementing the command is further configured to activate the command corresponding to the identified virtual option and the detected hand gesture.

3. The system of claim 2, wherein the detector is an infrared detector and the processing the detected data comprises identifying at least a virtual depth coordinate as a function the detected data detected from the infrared detector.

4. The system of claim 2, wherein the detector is a second camera mounted with the frame at a second location on the frame that is different than the first location and the detected data comprises a second image, and wherein the processor is further configured to process the first and second images received from the first and second cameras.

5. A system displaying a user interface, the system comprising:
a frame;
a lens mounted with the frame, where the frame is configured to be worn by a user to position the lens in a line of sight of the user;
a first camera mounted with the frame at a first location on the frame, where the first camera is positioned to align with a user's line of sight when the frame is appropriately worn by a user such that an image captured by the first camera corresponds with a line of sight of the user;
a second camera mounted with the frame at a second location on the frame that is different than the first location, where the second camera is positioned to align with a user's line of sight when the frame is appropriately worn by a user such that an image captured by the second camera corresponds with the line of sight of the user; and
a processor configured to:
process images received from the first and second cameras;
detect from the processing of the images a hand gesture relative to a three-dimensional (3D) space in the field of view of the first and second cameras;
identify from the processing of the images X, Y and Z coordinates within the 3D space of at least a portion of the hand performing the gesture;
identify a virtual option virtually displayed within the 3D space at the time the hand gesture is detected and corresponding to the identified X, Y and Z coordinates of the hand performing the gesture such that at least a portion of the virtual option is displayed to appear to the user as being positioned at the X, Y and Z coordinates;
identify a command corresponding to the identified virtual option and the detected hand gesture; and
activate the command corresponding to the identified virtual option and the detected hand gesture.

6. The system of claim 5, wherein the first camera is configured with a depth of field less than about four feet.

7. The system of claim 6, wherein the first camera is configured with the depth of field less than about the four feet defined extending from about six inches from the camera.

8. The system of claim 6, further comprising:
an infrared (IR) light emitter mounted with the frame and positioned to emit IR light into the field of view of the first and second cameras, wherein the first and second cameras comprise infrared filters to capture the infrared light, such that the first and second cameras are limited to detect IR light.

9. The system of claim 8, further comprising:
a communication interface mounted with the frame, wherein the communication interface is configured to communicate the images from the first and second cameras to the processor that is positioned remote from the frame.

10. The system of claim 6, further comprising:
a communication interface mounted with the frame, wherein the communication interface is configured to communicate the images from the first and second cameras to the processor that is positioned remote from the frame, and the communication interface is configured to receive graphics information to be displayed on the lens.

11. The system of claim 10, wherein the graphics comprise representations of the user's hand.

12. A method, comprising:
receiving, while a three dimensional presentation is being displayed, a first sequence of images captured by a first camera mounted on a frame worn by a user such that a field of view of the first camera is within a field of view of a user when the frame is worn by the user;
receiving, from a detector mounted with the frame, detector data of one or more objects within a detection zone that correspond with the line of sight of the user when the frame is appropriately worn by the user;
processing the first sequence of images;
processing the detected data detected by the detector;
detecting, from the processing of the first sequences of images, a predefined non-sensor object and a predefined gesture of the non-sensor object;
identifying, from the processing of the first sequence of images and the detected data, virtual X, Y and Z coordinates of at least a portion of the non-sensor object relative to a virtual three-dimensional (3D) space corresponding to the field of view of the first camera and the detection zone of the detector;
identifying a command corresponding to the detected gesture and the virtual 3D location of the non-sensor object; and
implementing the command.

13. The method of claim 12, wherein the receiving the detector data comprises receiving, while the three dimensional presentation is being displayed, a second sequence of images captured by a second camera mounted on the frame such that a field of view of the second camera is within the field of view of a user when the frame is worn by the user.

14. The method of claim 13, further comprising:
identify a virtual option virtually displayed within the three dimensional presentation configured to be displayed and within the field of view of the user, at the time the gesture is detected and corresponding to the three dimensional coordinate of the non-sensor object; and
the identifying the command comprises identifying the command corresponding to the identified virtual option and the gesture relative to the virtual option.

15. The method of claim 14, wherein the displaying the three dimensional presentation comprises displaying a simulation of the non-sensor object.

16. The method of claim 15, wherein the displaying the simulation of the non-sensor object comprises displaying the simulation on lenses mounted to the frame.
